(19) United States
(12) Patent Application Publication
(10) Pub. No.: US 2011/0303167 A1
(43) Pub. Date: Dec. 15, 2011

(54) INTERNAL COMBUSTION ENGINE

(75) Inventors: Thomas Krämer, Stuttgart (DE); Wolfgang Zücker, Ditzingen (DE); Stefan Moser, Ludwigsburg (DE); Thomas Laudenbach, Pleidelsheim (DE)

(73) Assignee: Dr. Ing. h.c. F. Porsche Aktiengesellschaft, Stuttgart (DE)

(21) Appl. No.: 13/151,560

(22) Filed: Jun. 2, 2011

(30) Foreign Application Priority Data
Jun. 11, 2010 (DE) 102010024005.2

(51) Int. Cl. F02B 75/22

(52) U.S. Cl. 123/54.1

(57) ABSTRACT

An internal combustion engine, having at least two cylinder banks, each cylinder bank having two outer high pressure cylinders and a central low pressure cylinder, reciprocating pistons of the cylinders being coupled via connecting rods to crankpin journals of a crankshaft, valves of the cylinders to be actuated via camshafts which can be driven from the crankshaft, crankpin journals on which the connecting rods of the high pressure cylinders act, lying in a common plane, crankpin journals on which the connecting rods of the low pressure cylinders act, being offset with respect to said plane, and the crankpin journal for the connecting rod of the low pressure cylinder of a first cylinder bank being offset with respect to the crankpin journal for the connecting rod of the low pressure cylinder of a second cylinder bank.

### CROSS-REFERENCE TO RELATED APPLICATION

This U.S. patent application claims priority to German Patent Application DE 102010024005.2, filed Jun. 11, 2010, which is incorporated by reference herein in its entirety.

### FIELD OF THE INVENTION

The invention relates to an internal combustion engine.

### BACKGROUND OF THE INVENTION

EP 1 961 943 A1, which is incorporated by reference herein, has disclosed an internal combustion engine having a plurality of cylinder banks, each cylinder bank having two outer high pressure cylinders which operate with fuel supply in the four stroke process and a central low pressure cylinder which operates without dedicated fuel supply in the two stroke process and is filled or loaded with exhaust gas from the two outer high pressure cylinders of the respective cylinder bank. Valves, namely inlet valves and outlet valves, of the cylinders of the cylinder banks of the internal combustion engine which is disclosed in this prior art can be actuated via camshafts. Reciprocating pistons of the cylinders of the cylinder banks are coupled to crankpin journals of a crankshaft. The camshafts of the cylinder banks can be driven from the crankshaft.

US 2009/0223482 A1, which is incorporated by reference herein, has disclosed a further internal combustion engine having two cylinder banks, of which each cylinder bank has in each case two outer high pressure cylinders which operate with fuel supply in the four stroke process and a central low pressure cylinder which operates without dedicated fuel supply in the two stroke process. In this prior art, reciprocating pistons of the cylinders of the cylinder banks are also coupled via connecting rods to a crankshaft, crankpin journals of this type of the crankshaft, on which crankpin journals the connecting rods of the high pressure cylinders act, lying in a common plane, whereas crankpin journals of this type of the crankshaft, on which crankpin journals the connecting rods of the low pressure cylinders act, are offset with respect to said plane as viewed in the rotational direction or circumferential direction of the crankshaft, namely by 90°. Reciprocating pistons of those cylinders of the different cylinder banks which lie opposite one another in the rotational direction of the crankshaft or in the circumferential direction of the crankshaft act via their respective connecting rods on common crankpin journals of the crankshaft. Thus, according to this prior art, the crankpin journals of the crankshaft, on which the reciprocating pistons of high pressure cylinders which lie opposite one another act jointly via their connecting rods, lie in a common plane, the crankpin journal of the crankshaft, on which the reciprocating pistons of those low pressure cylinders of the two cylinder banks which lie opposite one another in the circumferential direction of the crankshaft act jointly via their connecting rods, being offset with respect to said plane by 90°.

DE 31 21 301 A1, which is incorporated by reference herein, has disclosed a further internal combustion engine which has two cylinder banks with in each case three cylinders, namely with in each case two outer high pressure cylinders which operate with fuel supply in the four stroke process and a central low pressure cylinder which operates without dedicated fuel supply in the two stroke process, the low pressure cylinder of the respective cylinder bank being filled alternately with exhaust gas from the two outer high pressure cylinders of the respective cylinder bank. It is already known from this prior art to arrange the two cylinder banks with respect to one another in the form of an inline engine or in the form of a V engine or in the form of a boxer engine.

### SUMMARY OF THE INVENTION

Although it is already known from the prior art cited above to use the exhaust gas of the high pressure cylinders which operate with fuel supply in the four stroke process in the low pressure cylinders of the cylinder banks, which low pressure cylinders operate in the two stroke process, in order to increase the degree of efficiency of an internal combustion engine, there is a requirement for a further increase in the degree of efficiency of internal combustion engines of this type using simple means.

Proceeding from this, the present invention relates to an object of providing a novel internal combustion engine. This object is achieved by an internal combustion engine having at least two cylinder banks, each cylinder bank having two outer high pressure cylinders which operate with fuel supply in the four stroke process and a central low pressure cylinder which operates without fuel supply in the two stroke process and is filled alternately with exhaust gas from the high pressure cylinders of the respective cylinder bank, reciprocating pistons of the cylinders of the cylinder banks being coupled via connecting rods to crankpin journals of a crankshaft, it being possible for valves of the cylinders of the cylinder banks to be actuated via camshafts which can be driven from the crankshaft, crankpin journals of this type of the crankshaft, on which crankpin journals the connecting rods of the high pressure cylinders act, lying in a common plane, and crankpin journals of this type of the crankshaft, on which crankpin journals the connecting rods of the low pressure cylinders act, being offset with respect to said plane as viewed in the rotational direction or circumferential direction of the crankshaft, characterized in that the crankpin journal (37) for the connecting rod (32) of the low pressure cylinder (16) of a first cylinder bank (11) is offset as viewed in the rotational direction or circumferential direction of the crankshaft (13) with respect to the crankpin journal (38) for the connecting rod (32) of the low pressure cylinder (19) of a second cylinder bank (12). According to aspects of the invention, the crankpin journal for the connecting rod of the low pressure cylinder bank is offset as viewed in the rotational direction of the crankshaft with respect to the crankpin journal for the connecting rod of the low pressure cylinder of a second cylinder bank. By way of the offset according to aspects of the invention of the crankpin journals for the connecting rods of the low pressure cylinders of the cylinder banks, which low pressure cylinders lie opposite one another in the rotational direction or in the circumferential direction of the crankshaft, the degree of efficiency of the internal combustion engine can be increased using simple constructional means.

According to one advantageous development of the invention, the high pressure cylinders of the first cylinder bank and the high pressure cylinders of the second cylinder bank enclose a defined cylinder bank offset angle as viewed in the rotational direction of the crankshaft, the low pressure cylinder of the first cylinder bank being offset by a defined first cylinder skew offset angle with respect to the high pressure cylinders of said first cylinder bank, and the low pressure cylinder of the second cylinder bank being offset by a defined second cylinder skew offset angle with respect to the high pressure cylinders of said second cylinder bank.

When the low pressure cylinders are also offset with respect to the high pressure cylinders of the respective cylinder bank in the rotational direction of the crankshaft or the circumferential direction of the latter, the degree of efficiency of the internal combustion engine can be increased further.

According to a further advantageous development of the invention, the crankpin journals of the crankshaft, on which crankpin journals the connecting rods of the high pressure cylinders act, lie in a common plane, the crankpin journals of the crankshaft, on which crankpin journals the connecting rods of the low pressure cylinders act, being offset by a defined mean crankpin journal offset angle with respect to said plane in the rotational direction or circumferential direction of the crankshaft, the crankpin journal for the connecting rod of the low pressure cylinder of the first cylinder bank being offset by a first crankpin journal skew offset angle and the crankpin journal for the connecting rod of the low pressure cylinder of the second cylinder bank being offset by a second crankpin journal skew offset angle with respect to the mean crankpin journal offset angle.

### BRIEF DESCRIPTION OF THE DRAWINGS

Without being restricted thereto, exemplary embodiments of the invention will be explained in greater detail using the drawing, in which:

FIG. 1 shows a perspective view of a detail of one exemplary embodiment of an internal combustion engine according to aspects of the invention with two cylinder banks,

FIG. 2 shows a perspective view of a detail of the internal combustion engine from FIG. 1 in the region of a cylinder bank and camshafts which are assigned to said cylinder bank,

FIG. 3 shows a perspective view of a further detail of the internal combustion engine from FIG. 1 in the region of a crankshaft and cylinders which are coupled to the crankshaft via connecting rods,

FIG. 4 shows the detail of FIG. 4 in a front view,

FIG. 5 shows a view of valves of a cylinder bank of the internal combustion engine from FIG. 1,

FIGS. 6a to 6c show details of a crankshaft of the internal combustion engine according to a first variant of the invention,

FIGS. 7a to 7c show details of a crankshaft of the internal combustion engine according to a second variant of the invention, and

FIGS. 8a and 8b show details of a crankshaft of the crankshaft of the internal combustion engine according to a third variant of the invention.

### DETAILED DESCRIPTION OF THE PREFERRED EMBODIMENTS

The present invention relates to an internal combustion engine of a motor vehicle.

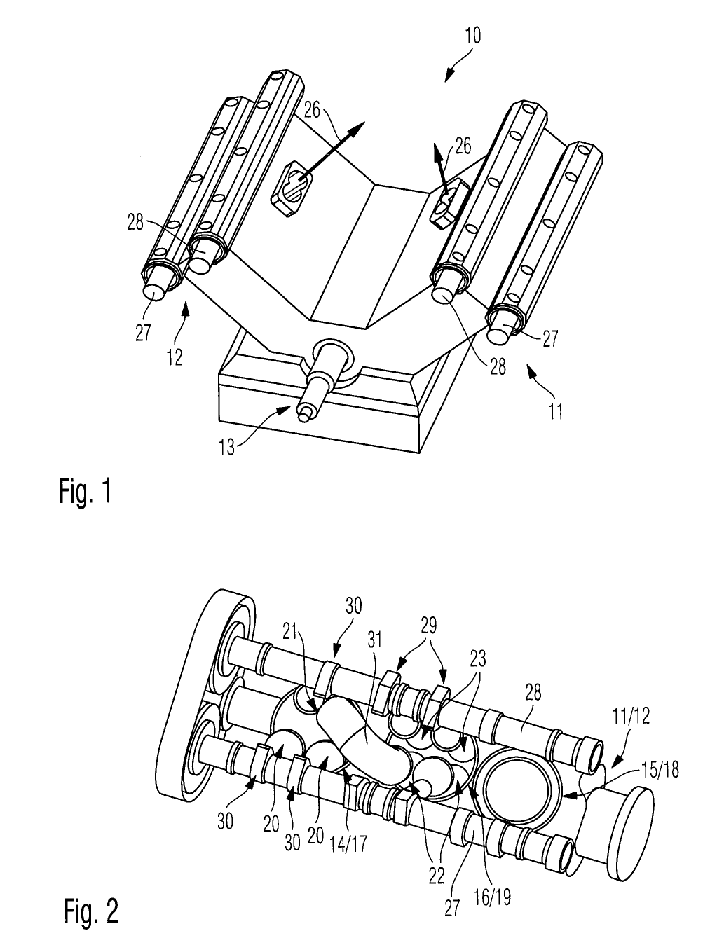

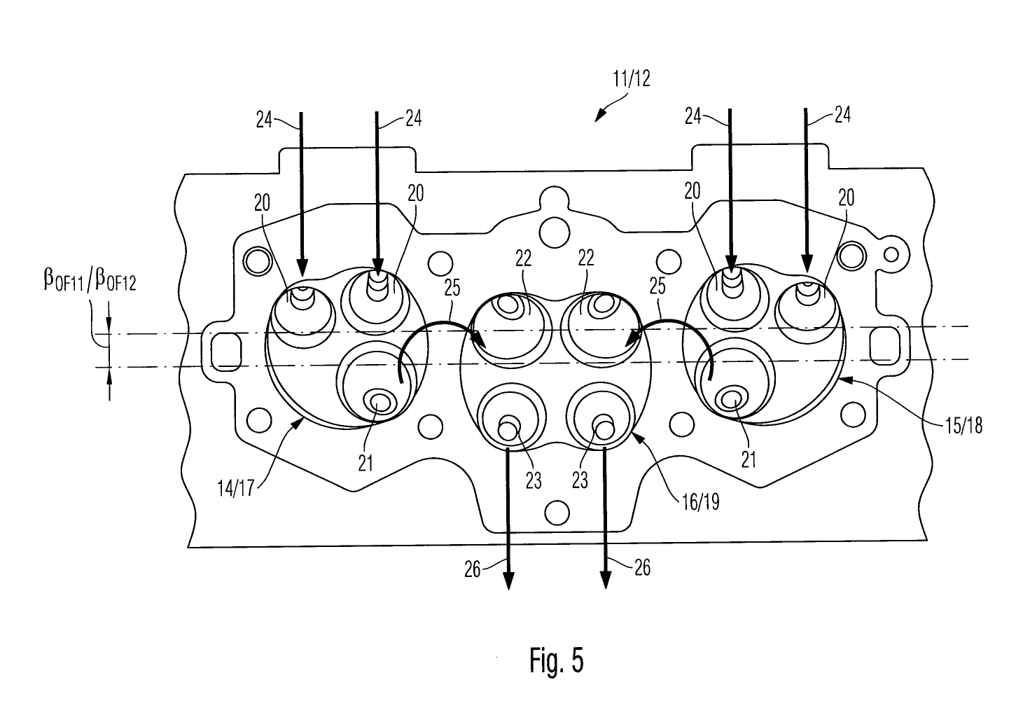

FIG. 1 shows a perspective view of one exemplary embodiment of an internal combustion engine 10 according to aspects of the invention which has two cylinder banks 11 and 12 which are arranged in a V position with respect to one another, each of the cylinder banks 11 and 12 comprising in each case three cylinders. FIG. 3 diagrammatically shows the cylinders of the two cylinder banks 11 and 12 together with a crankshaft 13.

A first cylinder bank 11 comprises two outer high pressure cylinders 14 and 15 which operate with fuel supply in the four stroke process and a central low pressure cylinder 16 which operates without dedicated fuel supply in the two stroke process and is filled alternately with exhaust gas from the high pressure cylinders 14, 15. The second cylinder bank 12 likewise comprises two outer high pressure cylinders 17 and 18 which operate with fuel supply in the four stroke process and a central low pressure cylinder 19 which operates without dedicated fuel supply in the two stroke process and is filled alternately with exhaust gas from the high pressure cylinders 17 and 18.

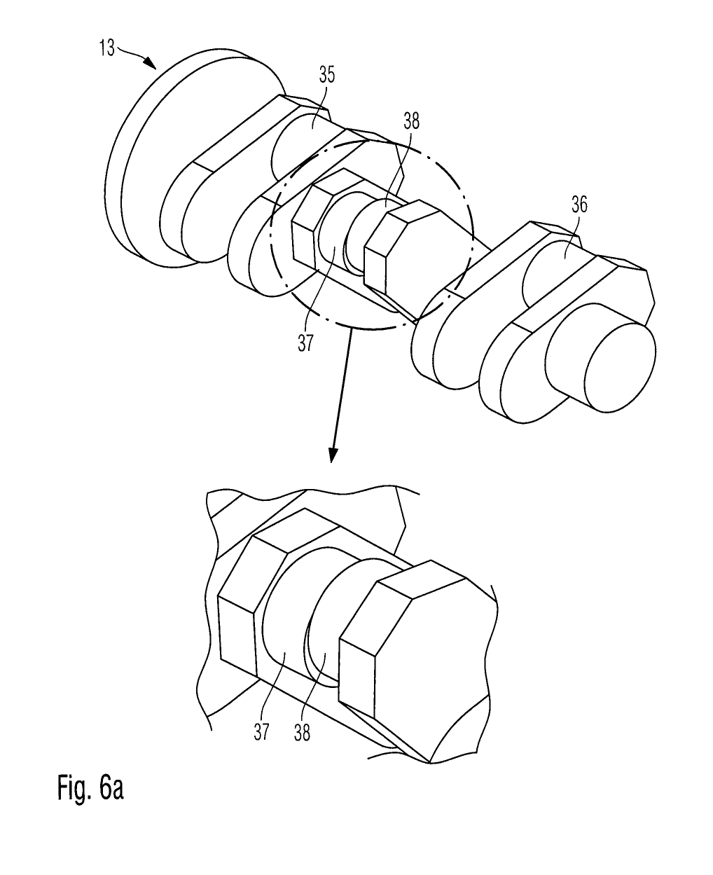

As can be gathered best from FIG. 3, the cylinders 14, 15 and 16 of the first cylinder bank 11 and the cylinders 17, 18 and 19 of the second cylinder bank 12 are positioned in each case in line with respect to one another, the cylinders 14, 15 and 16 of the first cylinder bank 11 lying opposite the cylinders 17, 18 and 19 of the second cylinder bank 12 in the rotational direction of the crankshaft 13 or in the circumferential direction of the latter. The cylinders of the cylinder banks 11 and 12 lie opposite one another in such a way that firstly high pressure cylinders 14, 17 and 15, 18 and secondly low pressure cylinders 16, 19 lie opposite one another. It can thus be gathered from FIGS. 3, 4 that the high pressure cylinders 14 and 17, the high pressure cylinders 15 and 18, and the low pressure cylinders 16 and 19 of the two cylinder banks 11 and 12 lie opposite one another in the rotational direction 34 of the crankshaft 13 or in the circumferential direction of the latter.

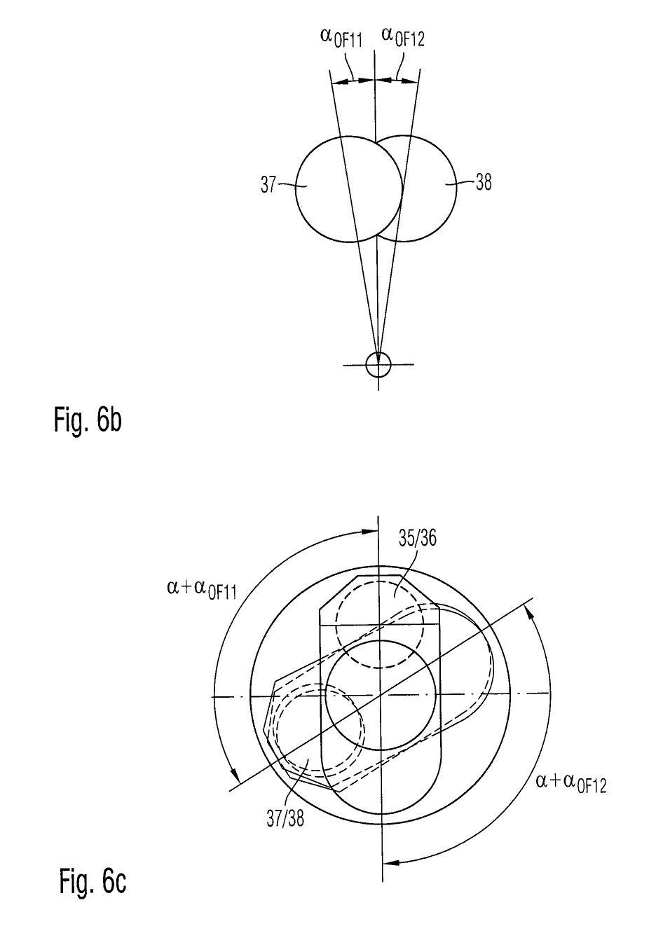

The cylinders of the two cylinder banks 11 and 12 are assigned valves. FIG. 5 shows a view of the valves of a cylinder bank 11 or 12 of the internal combustion engine according to aspects of the invention in the region of all the cylinders of the respective cylinder bank 11 or 12; according to FIG. 5, the two outer high pressure cylinders 14, 15 or 17, 18 which operate with fuel supply in the four stroke process comprise in each case two inlet valves 20 for fuel and combustion air or a fuel/combustion air mixture and in each case one outlet valve 21 for exhaust gas. When the high pressure cylinders operate with direct fuel injection, there are separate injection valves for fuel or combustible. The central low pressure cylinder 16 or 19 of the respective cylinder bank 11 or 12, which central low pressure cylinder 16 or 19 operates without dedicated fuel supply in the two stroke process, comprises two inlet valves 22 for exhaust gas and two outlet valves 23 for exhaust gas. As has already been mentioned, the low pressure cylinder 16 or 19 of each cylinder bank 11 or 12 is filled alternately with exhaust gas from the high pressure cylinders 14, 15 or 17, 18 of the respective cylinder bank 11, 12.

FIG. 5 uses arrows 24 to show the fuel and combustion air feed or the fuel/combustion air mixture feed to the respective outer high pressure cylinders of the cylinder banks. Arrows 25 visualize the crossflow of exhaust gas out of the outer high pressure cylinders 14, 15 or 17, 18 of the respective cylinder bank 11 or 12 into the respective low pressure cylinder 16 or 19 of said cylinder bank 11 or 12. Arrows 26 show the discharge of exhaust gas out of the respective low pressure cylinder 16, 19 of the respective cylinder bank 11, 12, it being possible for the exhaust gas to be fed either directly to an exhaust gas purification system or preferably to an exhaust gas turbocharger for a further increase in the degree of efficiency.

The abovementioned valves of the cylinders of the cylinder banks 11 and 12 can be actuated via camshafts 27 and 28, namely via what are known as inlet camshafts 27 and what are known as outlet camshafts 28. Here, the inlet valves 20 of the high pressure cylinders 14, 15 or 17, 18 and the inlet valves 22 of the low pressure cylinders 16 or 19 are actuated via the respective inlet camshaft 27 of the respective cylinder bank 11 or 12, whereas the outlet valves 21 of the high pressure cylinders 14, 15 or 17, 19 and the outlet valves 23 of the low pressure cylinder 16 or 19 of the respective cylinder bank 11 or 12 are actuated by the respective outlet camshaft 28 of the respective cylinder bank 11 or 12.

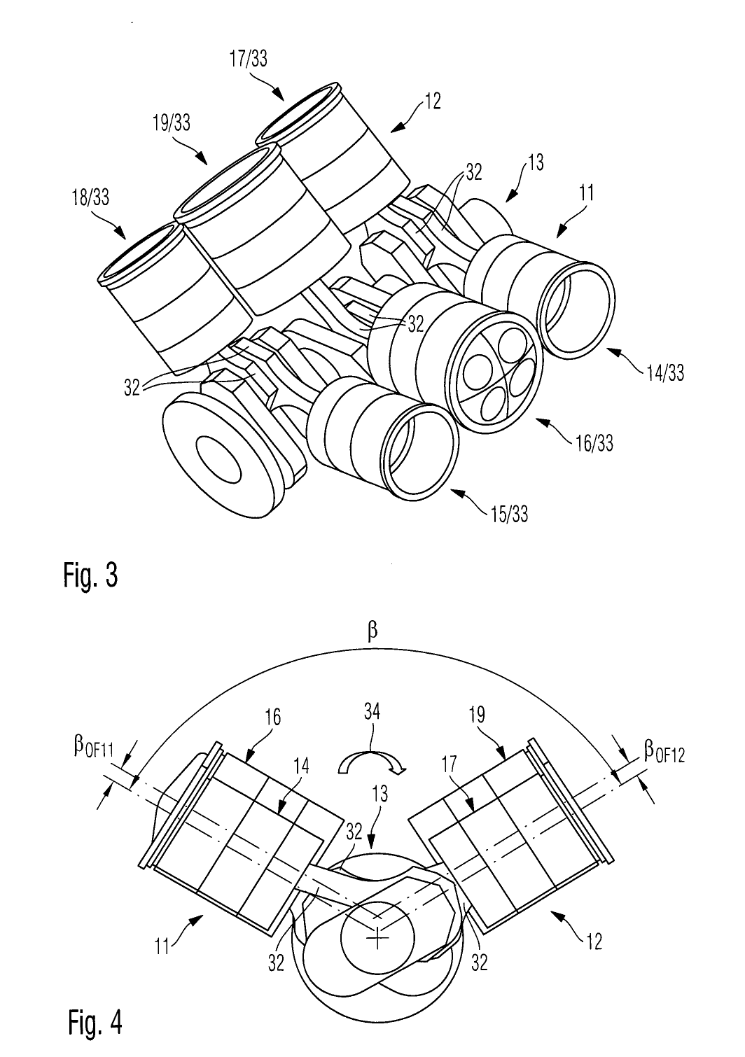

As has already been described, the high pressure cylinders 14, 15 and 17, 18 of the two cylinder banks 11 and 12 operate in the four stroke process, whereas the low pressure cylinders 16 and 19 of the cylinder banks 11, 12 operate in the two stroke process. Here, the low pressure cylinders 16 and 19 are filled alternately with exhaust gas from the high pressure cylinders 14, 15 or 17, 18 of the respective cylinder bank, as a result of which a different temporal actuation is required for the outlet valves 23 of the low pressure cylinders 16 and 19 of the cylinder banks 11 and 12 than for the remaining valves of the cylinders of the cylinder banks 11, 12. Therefore, according to FIG. 2, cams which are configured as double cams 29 are positioned on the outlet camshaft 28 of the respective cylinder bank 11 or 12 for actuating the outlet valves 23 of the low pressure cylinder 16 or 19 of the respective cylinder bank 11 or 12, whereas the cams for actuating the remaining valves 20, 21 and 22 of the cylinders of the respective cylinder bank 11 or 12 are configured as single cams 30.

In order to ensure the crossflow of the exhaust gas from the high pressure cylinders 14, 15 or 17, 18 of the cylinder banks 11, 12 into the low pressure cylinder 16, 19 of the respective cylinder bank, there are crossflow channels, FIG. 2 showing a crossflow channel 31 of this type.

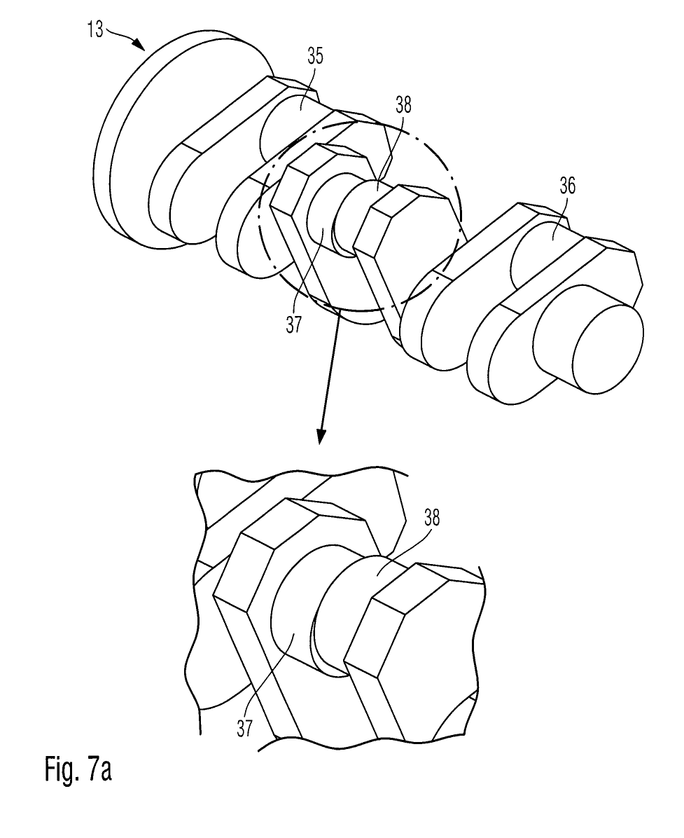

The internal combustion engine 10 has the crankshaft 13, it being possible for the camshafts 27, 28 of the cylinder banks 11, 12 to be driven via the crankshaft 13. Reciprocating pistons 33 of the cylinders 14 to 19 of the two cylinder banks 11 and 12 are coupled to the crankshaft 13 via connecting rods 32 (see FIGS. 3, 4), the connecting rods 32 of the reciprocating pistons 33 acting on what are known as crankpin journals of the crankshaft 13. Said crankpin journals will be discussed with reference to FIGS. 6a to 6c, FIGS. 7a to 7c and FIGS. 8a and 8b.

As has already been described, the cylinder banks 11 and 12 of the internal combustion engine 10 in the exemplary embodiment shown are positioned with respect to one another so as to ensure a V design, namely according to FIG. 4 in such a way that the high pressure cylinders 14 and 15 of the first cylinder bank 11 and the high pressure cylinders 17 and 18 of the second cylinder bank 12 enclose a defined cylinder bank offset angle β as viewed in the rotational direction 34 or circumferential direction of the crankshaft 13. According to FIG. 4, said cylinder bank offset angle β is, for example, 120°. However, the defined cylinder bank offset angle β can also be 90° or 180°. Furthermore, other cylinder bank offset angles β are also conceivable.

Furthermore, as can be gathered from FIG. 4, the low pressure cylinder 16 of the first cylinder bank 11 is offset by a first defined cylinder skew offset angle β_{OF11} with respect to the high pressure cylinders 14 and 15 of said first cylinder bank 11. The low pressure cylinder 19 of the second cylinder bank 12 is offset by a second defined cylinder skew offset angle β_{OF12} with respect to the high pressure chambers 17, 18 of said second cylinder bank 12.

Here, according to FIG. 4, said cylinder skew offset angles β_{OF11} and β_{OF12} are preferably of equally great magnitude, but they have different algebraic signs. In FIG. 4, the low pressure cylinder 16 of the cylinder bank 11 is offset by the cylinder skew offset angle β_{OF11} with respect to the high pressure cylinders 14 and 15 of said cylinder bank 11 in the rotational direction 34 of the crankshaft 13, whereas the low pressure cylinder 19 of the cylinder bank 12 is offset by the cylinder skew offset angle β_{OF12} with respect to the high pressure cylinders 17, 18 of said cylinder bank 12 in the opposite direction to the rotational direction 34 of the crankshaft 13.

As has already been described, the two cylinder skew offset angles β_{OF11} and β_{OF12} accordingly have different algebraic signs, but they are preferably of equally great magnitude. However, it is also possible that the magnitudes of the two cylinder skew offset angles β_{OF11} and β_{OF12} also differ from one another. The cylinder skew offset angles β_{OF11} and β_{OF12} have a magnitude between 1° and 10°.

As a result of the above offset of the low pressure cylinders 16 and 19 with respect to the high pressure cylinders 14, 15 and 17, 18 of the cylinder banks 11 and 12, crossflow channels 31 with relatively small volumes can be provided. A small volume in a crossflow channel 31 minimizes losses during the expansion of the exhaust gas which is to be transferred via the respective crossflow channel 31. This has positive effects on the degree of efficiency which can be achieved with the internal combustion engine.

The offset in opposite directions is advantageous, in particular, when the exhaust gases, starting from the low pressure cylinders 16, 19, are to be fed to an exhaust gas turbocharger in order to further increase the degree of efficiency which can be realized with the internal combustion engine.

As has already been described, the reciprocating pistons of the cylinders 14 to 19 of the cylinder banks 11 and 12 act via their connecting rods 32 on the crankshaft 13, namely on crankpin journals of the crankshaft 13.

FIGS. 6a to 6c show details of the crankshaft 13 of the internal combustion engine 10 according to a first variant of the invention; according to FIGS. 6a to 6c, there is in each case a common crankpin journal 35 or 36 for the connecting rods 32 of high pressure cylinders 14, 17 and 15, 18, which lie opposite one another, of the cylinder banks 11 and 12 which lie opposite one another. The connecting rods 32 of the high pressure cylinders 14 and 17, which lie opposite one another, of the cylinder banks 11 and 12 thus jointly act on the crankpin journal 35 of the crankshaft 13, whereas the connecting rods 32 of the high pressure cylinders 15 and 18, which lie opposite one another, of the cylinder banks 11 and 12 which lie opposite one another act jointly on the crankpin journal 36 of the crankshaft 13.

The two crankpin journals 35 and 36 for the connecting rods 32 of the high pressure cylinders 14, 17 and 15, 18 lie on a circumferential position as viewed in the rotational direction of the crankshaft 13; accordingly, they are not offset with respect to one another in the circumferential direction or rotational direction of the crankshaft 13, with the result that the crankpin journals 35 and 36 for the reciprocating pistons of the high pressure cylinders 14, 15, 17 and 18 of both cylinder banks 11 and 12 lie in a common plane, namely even on a common straight line according to FIG. 6a.

There are separate crankpin journals 37 and 38 for the connecting rods 32 of the low pressure cylinders 16 and 19, which lie opposite one another, of the two cylinder banks 11 and 12 which lie opposite one another.

The crankpin journals 37 and 38 for the connecting rods 32 of the low pressure cylinders 16 and 19 are offset in the rotational direction 34 of the crankshaft 13 or in the circumferential direction of the latter with respect to the plane, in which the crankpin journals 35 and 36 for the connecting rods 32 of the high pressure cylinders 14, 15, 17 and 18 lie. Furthermore, the crankpin journals 37 and 38 for the connecting rods of the low pressure cylinders 16 and 19 are offset with respect to one another as viewed in the rotational direction of the crankshaft 13. The crankpin journal 37 for the connecting rod 32 of the low pressure cylinder 16 of the cylinder bank 11 is thus offset with respect to the crankpin journal 38 for the connecting rod 32 of the low pressure cylinder 19 of the cylinder bank 12 as viewed in the rotational direction 34 of the crankshaft 13.

As has already been described, the crankpin journals 35 and 36, on which the connecting rods 32 of the high pressure cylinders 14, 17 and 15, 18 of the two cylinder banks 11 and 12 which lie opposite one another act, lie in a common plane. In contrast, the crankpin journals 37 and 38 of the crankshaft 13, on which crankpin journals 37 and 38 the connecting rods 32 of the low pressure cylinders 16 and 19 act, are offset on average by a defined, mean crankpin journal offset angle α with respect to said plane as viewed in the rotational direction 34 of the crankshaft 13.

The crankpin journals 37 for the connecting rod 32 of the low pressure cylinder 16 of the cylinder bank 11 is offset by a first crankpin journal skew offset angle α_{OF11} with respect to the mean crankpin journal offset angle α. The crankpin journal 38 for the connecting rod 32 of the low pressure cylinder 19 of the cylinder bank 12 is offset by a second crankpin journal skew offset angle α_{OF12} with respect to the mean crankpin journal offset angle α.

It can be gathered from FIGS. 6b and 6c that the two crankpin journal skew offset angles α_{OF11} and α_{OF12} have different algebraic signs here, but are preferably of equally great magnitude. The defined, mean crankpin journal offset angle α_{OF} is between 75° and 120°, in particular is 90° or 120°.

The crankpin journal skew offset angles α_{OF11} and α_{OF12} are preferably calculated from the above-described cylinder skew offset angles β_{OF11} and β_{OF12} according to the following formulae:

$$sin {α}_{OF 11} = \frac{{β}_{OF 11}}{l + 0.5 * h}$$

$$sin {α}_{OF 12} = \frac{{β}_{OF 12}}{l + 0.5 * h}$$

in which l is the connecting rod length of the connecting rod 32 of the respective low pressure cylinder 16 or 19 and h is the stroke length of the reciprocating piston of the respective low pressure cylinder 16 or 19.

In the variant of FIGS. 6a to 6c, the mean crankpin journal offset angle α is 120°. The two crankpin journals 37 and 38 are offset with respect to said mean crankpin journal offset angle α by their respective offset angles α_{OF11} and α_{OF12}, namely with the same magnitudes but different algebraic signs, once in the rotational direction and once in the opposite direction to the rotational direction of the crankshaft 13.

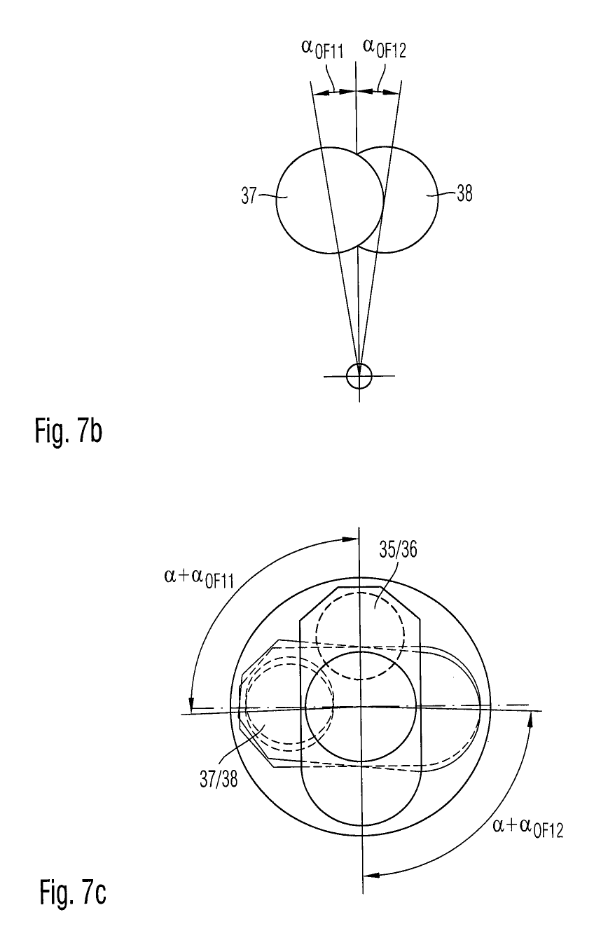

FIGS. 7a to 7c show a variant of the crankshaft 13, in which the mean crankpin journal offset angle α between the crankpin journals 37, 38 for the reciprocating pistons of the low pressure cylinders and the plane, in which the crankpin journals 35, 36 for the reciprocating pistons of the high pressure cylinders lie, is 90°. Here, in accordance with the variant of FIGS. 6a to 6c, the two crankpin journals 37 and 38 for the connecting rods 32 of the central low pressure cylinders 16 and 19 are once again offset with respect to one another by their crankpin journal skew offset angles α_{OF11} and α_{OF12} with different algebraic signs but the same magnitudes with respect to the mean crankpin journal offset angle α.

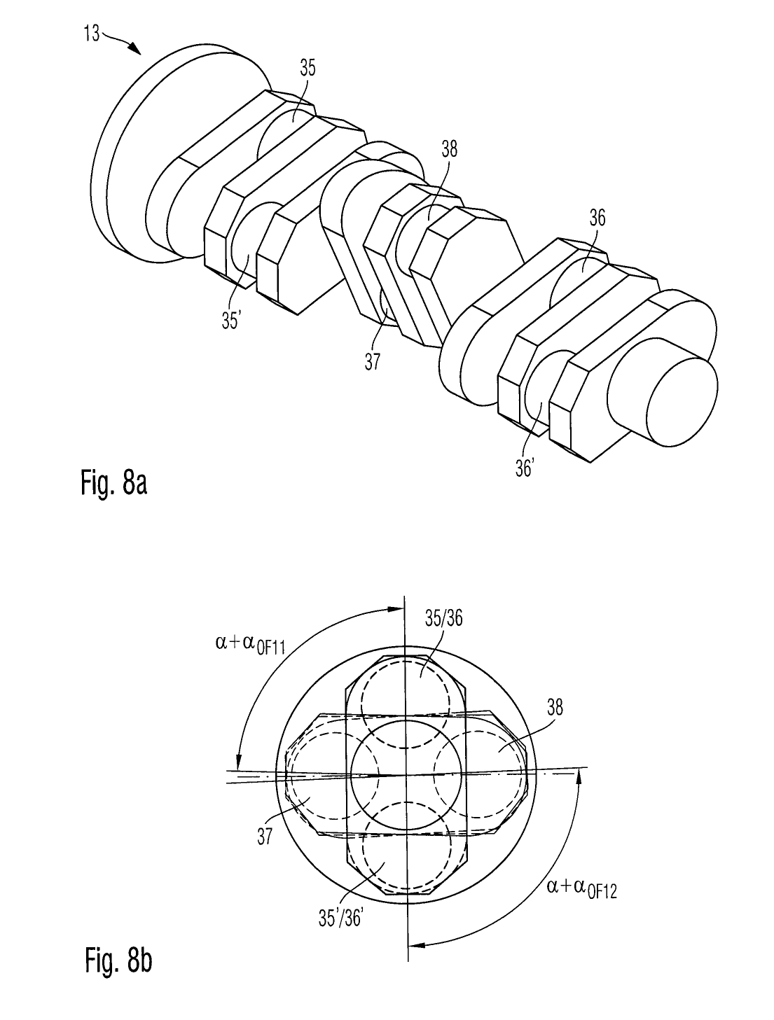

FIGS. 8a and 8b show a further variant of a crankshaft 13 for an internal combustion engine according to aspects of the invention. In FIGS. 8a and 8b, there is a separate crankpin journal for each connecting rod 32 of the cylinders 14 to 18 of the two cylinder banks 11 and 12, that is to say not only separate crankpin journals 37 and 38 for the connecting rods 32 of the low pressure cylinders 16 and 19 of the two cylinder banks 11 and 12, but also separate crankpin journals 35, 35′, 36, 36′ for the connecting rods 32 of the high pressure cylinders 14, 15, 17 and 18 of the two cylinder banks 11 and 12. Here, the crankpin journals 35 and 35′, just like the crankpin journals 36 and 36′, for the connecting rods 32 of the high pressure cylinders 14, 17 and 15, 18 which in each case lie opposite one another are offset with respect to one another by 180°, with the result that accordingly all the crankpin journals 35, 35′, 36, 36′ for the high pressure cylinders 14, 15, 17 and 18 once again lie in one plane.

The crankpin journals 37 and 38 for the low pressure cylinders 16 and 19 of the two cylinder banks 11 and 12 are offset with respect to said plane and with respect to one another as viewed in the circumferential direction or rotational direction of the crankshaft 13.

Here, in the exemplary embodiment shown of FIGS. 8a and 8b, the mean crankpin journal offset angle α of the crankpin journals 37, 38 for the low pressure cylinders 16, 19 of the cylinder banks 11, 12 with respect to the crankpin journals 35 and 36 or 35′ and 36′ for the high pressure cylinders 14 and 15 or 16 and 17 of the respective cylinder bank 11 or 12 is 90°, the crankpin journals 37 and 38 for the central low pressure cylinders 16 and 19 being offset, however, with respect to said mean crankpin journal offset angle α in each case by a crankpin journal skew offset angle α_{OF11} and α_{OF12}, to be precise with different algebraic signs but preferably identical magnitudes.

The crankshaft 13 of the variant according to FIGS. 8a and 8b is used, in particular, when the cylinder banks 11 and 12 of the internal combustion engine 10 are offset with respect to one another with the formation of a 180° V engine.

### LIST OF DESIGNATIONS

10 Internal combustion engine
11 Cylinder bank
12 Cylinder bank
13 Crankshaft
14 High pressure cylinder
15 High pressure cylinder
16 Low pressure cylinder
17 High pressure cylinder
18 High pressure cylinder
19 Low pressure cylinder
20 Inlet valve
21 Outlet valve
22 Inlet valve
23 Outlet valve
24 Fuel supply
25 Exhaust gas crossflow
26 Exhaust gas discharge
27 Inlet camshaft
28 Outlet camshaft
29 Double cam
30 Single cam
31 Crossflow channel
32 Connecting rod
33 Reciprocating piston
34 Crankshaft rotational direction
35, 35′ Crankpin journal
36; 36′ Crankpin journal
37 Crankpin journal
38 Crankpin journal

1.-9. (canceled)

10. An internal combustion engine comprising:
at least two cylinder banks, each cylinder bank having two outer high pressure cylinders which operate with fuel supply in a four stroke process and a central low pressure cylinder which operates without fuel supply in a two stroke process and is filled alternately with exhaust gas from the high pressure cylinders of the respective cylinder bank,
reciprocating pistons of the cylinders of the cylinder banks being coupled via connecting rods to crankpin journals of a crankshaft,
valves of the cylinders of the cylinder banks are actuated via camshafts which are configured to be driven from the crankshaft,
the crankpin journals, on which the connecting rods of the high pressure cylinders act, lie in a common plane,
the crankpin journals, on which the connecting rods of the low pressure cylinders act, are offset with respect to said common plane as viewed in a rotational direction or a circumferential direction of the crankshaft,
wherein the crankpin journal for the connecting rod of the low pressure cylinder of a first cylinder bank is offset as viewed in the rotational direction or circumferential direction of the crankshaft with respect to the crankpin journal for the connecting rod of the low pressure cylinder of a second cylinder bank.

11. The internal combustion engine as claimed in claim 10, wherein the high pressure cylinders of the first cylinder bank and the high pressure cylinders of the second cylinder bank enclose a defined cylinder bank offset angle as viewed in the rotational direction or circumferential direction of the crankshaft, and wherein the low pressure cylinder of the first cylinder bank is offset by a defined first cylinder skew offset angle with respect to the high pressure cylinders of said first cylinder bank, and wherein the low pressure cylinder of the second cylinder bank is offset by a defined second cylinder skew offset angle with respect to the high pressure cylinders of said second cylinder bank.

12. The internal combustion engine as claimed in claim 11, wherein the defined first cylinder skew offset angle and the defined second cylinder skew offset angle are of equally great magnitude but have different algebraic signs.

13. The internal combustion engine as claimed in claim 11, wherein the defined cylinder bank offset angle is 90°, 120° or 180°.

14. The internal combustion engine as claimed in claim 11, wherein the defined cylinder skew offset angles are between 1° and 10°.

15. Internal combustion engine as claimed in claim 11,
wherein the crankpin journals, on which the connecting rods of the high pressure cylinders act, lie in a common plane,
wherein the crankpin journals, on which the connecting rods of the low pressure cylinders act, are offset by a defined mean crankpin journal offset angle with respect to said common plane in the rotational direction or circumferential direction of the crankshaft,
the crankpin journal for the connecting rod of the low pressure cylinder of the first cylinder bank being offset by a first crankpin journal skew offset angle and the crankpin journal for the connecting rod of the low pressure cylinder of the second cylinder bank being offset by a second crankpin journal skew offset angle with respect to the mean crankpin journal offset angle.

16. The internal combustion engine as claimed in claim 15, wherein the first crankpin journal skew offset angle and the second crankpin journal skew offset angle are of equally great magnitude but have different algebraic signs.

17. The internal combustion engine as claimed in claim 15, wherein the defined mean crankpin journal offset angle is between 75° and 120°.

18. The internal combustion engine as claimed in claim 15, wherein the defined mean crankpin journal offset angle is between 90° and 120°.

19. The internal combustion engine as claimed in claim 15, wherein each crankpin journal skew offset angle is calculated from a respective cylinder skew offset angle as follows:
$$sin {α}_{OF} = \frac{{β}_{OF}}{l + 0.5 * h}$$
in which ‘l’ is the connecting rod length of the respective connecting rod and ‘h’ is the stroke length of the reciprocating piston of the respective cylinder.
